(19) United States
(12) Patent Application Publication
(10) Pub. No.: US 2010/0077860 A1
(43) Pub. Date: Apr. 1, 2010

(54) SYSTEMS AND METHODS FOR INTEGRATED ISOLATOR AND TRANSDUCER COMPONENTS IN AN INERTIAL SENSOR

(75) Inventor: Owen Grossman, Golden Valley, MN (US)

Correspondence Address: HONEYWELL/FOGG;Patent Services, 101 Columbia Road, P.O Box 2245, Morristown, NJ, 07962-2245, US

(73) Assignee: Honeywell International Inc., Morristown, NJ (US)

(21) Appl. No.: 12/241,968

(22) Filed: Sep. 30, 2008

(51) Int. Cl. G01P 15/105; G01P 15/125

(52) U.S. Cl. 73/514.31; 73/514.32

(57) ABSTRACT

The present invention generally relates to systems and methods for determining precision vehicle orientation information. The system includes an inertial measurement unit having a chassis with a first interior surface, an inertial sensor assembly disposed within the chassis and having a first exterior surface, and integrated suspension elements mounted to the first interior surface and the first exterior surface. The integrated suspension elements include a first sensor that senses a displacement measurement of the inertial sensor assembly with respect to the chassis. The displacement measurement is used to determine an angular deflection.

### BACKGROUND OF THE INVENTION

Inertial measurement units (IMUs) are used in a variety of applications. An IMU is the main component of inertial guidance systems used in air and space vehicles, watercraft vehicles, guided missiles, and a variety of gun and artillery applications. IMUs work by detecting acceleration rates as well as changes in rotational positions (e.g., pitch, roll, and yaw), by using various combinations of accelerometers and gyroscopic sensors. Data collected from these sensors allow a computer to track a vehicle's position using a variety of vehicle positioning techniques, such as dead reckoning. An IMU typically includes a chassis housing an inertial sensor assembly (ISA) that contains multiple sensor components. The performance of the IMU and the accuracy of its inertial measurement output depend on vibration and shock isolation of the ISA within the chassis of the IMU.

One method of compensating for the vibration and shock experienced by an ISA is to mount the ISA within a chassis using shock absorbing isolator elements. In this configuration, the dampened displacement of the ISA is measured with separate sensing elements disposed between the isolator mounted ISA and the chassis. These displacement measurements are then subtracted from the ISA measurements to provide for an IMU output indicating an angular deflection.

FIG. 1 shows a prior art IMU having a chassis that houses a suspended ISA. In this configuration, the ISA is mounted to the chassis with multiple shock absorbing isolators. The IMU also contains multiple capacitive sensing elements that sense displacement measurements of the ISA within the IMU during a shock or vibration event. This isolation scheme allows the ISA to rotate through an angle relative to the chassis due to a number of other factors such as temperature, linear and angular acceleration, age, etc. Any misalignment or movement of the ISA within the chassis can be detected by the capacitive sensing elements and then eliminated from the acceleration and rotational measurements of the ISA using angular deflection data determined by external signal processing components (e.g., signal conditioning and inertial solution processors).

FIG. 2 shows a prior art IMU having electro-magnetic sensing elements. In this configuration, ISA displacement is measured by detecting an induced electro-magnetic effect (e.g., a raised inductive current). Similar to the IMU of FIG. 1, the sensed movement of the ISA within the chassis is removed from the acceleration and rotational measurements of the ISA using determined angular deflection data.

At present, the process of fabricating IMUs with distinct isolator and displacement sensor components (e.g., FIGS. 1 and 2) is expensive and requires separate fabrication processing steps. Further, the spacing inside the chassis of an IMU can become overly crowded with multiple isolator and sensing elements that reduce ISA range of movement.

### SUMMARY OF THE INVENTION

The present invention generally relates to systems and methods for determining precision vehicle orientation information. In accordance with one aspect of the present invention, an inertial measurement unit (IMU) includes a chassis having a first interior surface, an inertial sensor assembly (ISA) disposed within the chassis and having a first exterior surface, and integrated suspension elements mounted to the first interior surface and the first exterior surface. In this embodiment, the integrated suspension elements include sensors that sense a displacement measurement of the ISA with respect to the chassis. The displacement measurement is used to determine an angular deflection.

In accordance with further aspects of the invention, the integrated suspension elements have elastomeric isolators and either capacitive or electro-magnetic transducers.

In accordance with another aspect of the invention, a method for determining precision vehicle orientation information with an inertial sensor assembly (ISA) disposed within a chassis of an IMU, includes sensing a first and a second displacement measurement with a first and a second integrated suspension element, wherein the first and second integrated suspension elements are attached to both the ISA and the chassis. The method further includes comparing the first and second displacement measurements and determining an angular deflection of the ISA based on the compared first and second displacement measurements.

In accordance with yet other aspects of the invention, the first and second integrated suspension elements independently measure isolator compression to determine an angular deflection.

### BRIEF DESCRIPTION OF THE DRAWINGS

Preferred and alternative embodiments of the present invention are described in detail below with reference to the following drawings:

FIG. 1 is a schematic view of a prior art apparatus having a capacitive transducer;

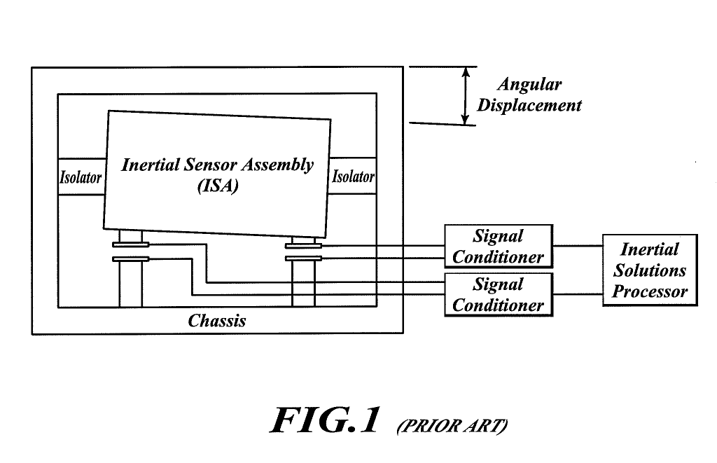

FIG. 2 is a schematic view of a prior art apparatus having a linear variable differential transducer;

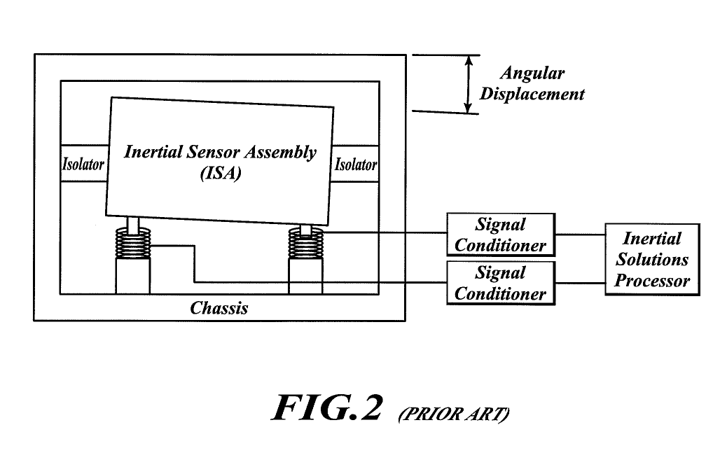

FIG. 3 is a cross-section view of an IMU having an integrated isolator with a capacitive transducer in accordance with an embodiment of the present invention;

FIG. 4 is a cross-section view of an IMU having an integrated isolator with a linear variable differential transducer in accordance with an embodiment of the present invention;

FIG. 5 is a cross-section view of an IMU having an integrated isolator with an inductive transducer in accordance with an embodiment of the present invention;

FIG. 6 is a cross-section view of an IMU having an integrated isolator with an eddy current transducer in accordance with an embodiment of the present invention; and

FIG. 7 is a cross-section view of an IMU having an integrated isolator with an active transducer in accordance with an embodiment of the present invention.

### DETAILED DESCRIPTION OF THE INVENTION

The present invention relates to systems and methods for determining precision vehicle orientation information with an Inertial Measurement Unit (IMU) having integrated suspension elements. Each integrated suspension element includes both a shock absorbing isolator and a transducer that detects displacement measurements of an Inertial Sensor Assembly (ISA) within the chassis of the IMU. Angular deflection of an ISA is typically caused by external forces, such as vibration and shock events. However, other causes of misalignment can include temperature change, acceleration loads, component aging, etc.

The ISA includes multiple sensor components (e.g., accelerometer and gyroscopic sensors) (not shown) that independently detect vehicle acceleration rates as well as changes in vehicle rotational position rates. The integrated suspension elements include transducers that sense displacement measurements, which are utilized by external processors to determine the angular deflection of the ISA. This angular deflection is then eliminated from the detected vehicle acceleration and rotational position measurements to provide for more accurate IMU output.

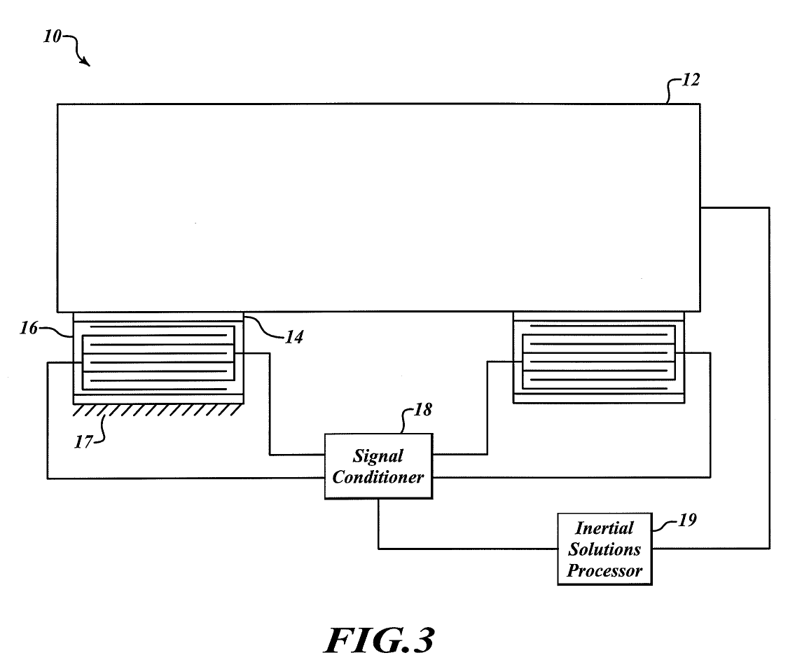

FIG. 3 illustrates an IMU 10 in accordance with an embodiment of the present invention. The IMU 10 includes an ISA 12, multiple integrated isolators 14 having capacitive transducers 16, and a chassis 17. The integrated isolators 14 are electrically connected to external processors, including a signal conditioner 18 and an inertial solutions processor 19. The integrated isolators 14 are each attached to one interior surface of the chassis 17 and to one exterior surface of the ISA 12, allowing the ISA 12 to remain suspended within the chassis 17. In an embodiment, the integrated isolators 14 are attached to any or multiple interior surfaces of the chassis 17. Likewise, the integrated isolators 14 are attachable to any or multiple external surfaces of the ISA 12.

The integrated isolators 14 are composed of a compressible dielectric material (e.g., an elastomeric dielectric) that allows the ISA to resistively move about within the IMU chassis 17. The capacitive transducers 16 are built into the integrated isolators 14 in layers (e.g., as a stack of interleaved foil plates with dielectric material interposed between each set of plates). When a compression or expansion event occurs, the dielectric material compresses or expands, changing the relative capacitance of the transducers 16. When the capacitive plates of the transducer 16 are positioned closer together, capacitance increases, and vise versa.

In an embodiment, the change in capacitance is converted to a voltage value by a capacitance bridge circuit (not shown). In this embodiment, a capacitance bridge creates a small voltage signal that is passed to an amplifier to increase the voltage value. In an embodiment, a capacitance signal is sensed and conditioned by the signal conditioner 18, and then transmitted to the inertial solutions processor 19, which compares multiple displacement measurements and determines an angular deflection of the ISA 12 within the chassis 17.

The determined angular deflection of the ISA 12 is then eliminated from detected vehicle acceleration and rotational position measurements of the ISA sensors. In this way, adverse vibration and shock effects can be eliminated from ISA sensor measurements. In various embodiments, this displacement error compensation occurs either at the inertial solutions processor 19 or at a processor resident in the ISA 12.

As an alternative to integrating isolator components 14 with capacitive transducers 16, various electro-magnetic transducers (not shown) can also be integrated into the isolator components 14. Certain advantages are associated with these alternate embodiments. For example, the capacitive transducer embodiment typically operates more effectively in high frequency environments with smaller ISA deflection, whereas the electro-magnetic transducer embodiments typically operate more effectively in low-frequency environments, with larger ISA deflection.

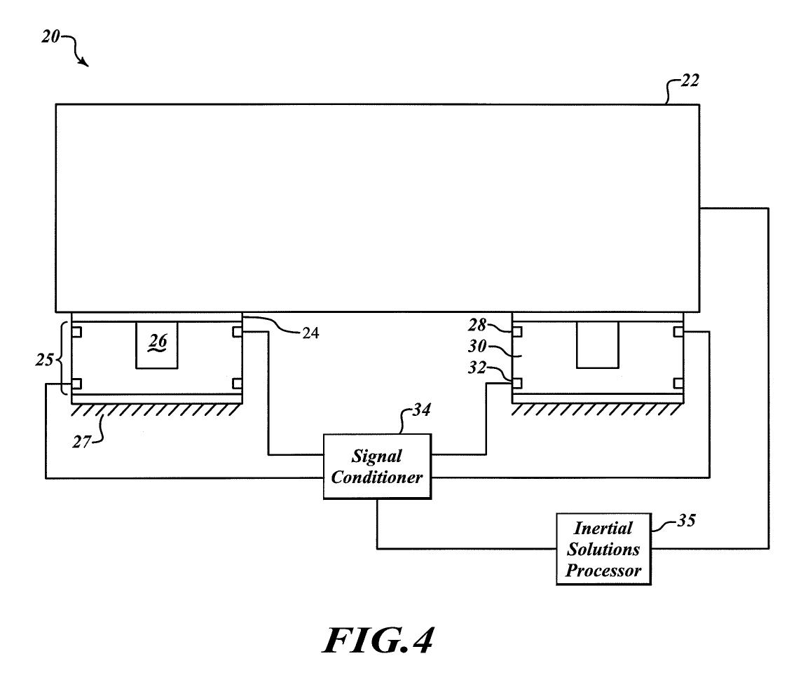

FIG. 4 illustrates an IMU 20 in accordance with another embodiment of the present invention. The IMU 20 includes an ISA 22, multiple integrated isolators 24, and a chassis 27. The integrated isolators 24 each have a linear variable differential transducer (LVDT) 25 and a shock absorbing component 30 (e.g., an elastomeric or plastic material). The LVDT 25 includes a magnetic core 26, a primary coil 32, and a secondary coil 28, which are each positioned within the shock absorbing component 30 of the integrated isolators 24. The magnetic core 26 is positioned inside of the secondary coil 28, which is positioned above the primary coil 32. When an isolator 24 is compressed, the magnetic core 26 moves inside of the primary coil 32.

In this embodiment, as an isolator 24 is compressed or extended, the magnetic core 26 and the secondary coil 28 change position relative to the primary coil 32. This change of position causes a corresponding change in an AC voltage that is coupled from the primary 32 and secondary coils 28. This AC voltage is applied to the primary coil 32 which induces an AC current in the secondary coil 28. The degree of coupling changes as the compression of the isolator 24 changes.

A representative voltage signal is sensed and conditioned by the signal conditioner 34. The conditioned signal is then transmitted to the inertial solutions processor 35, which compares multiple displacement measurements to determine an angular deflection of the ISA 22 within the chassis 27.

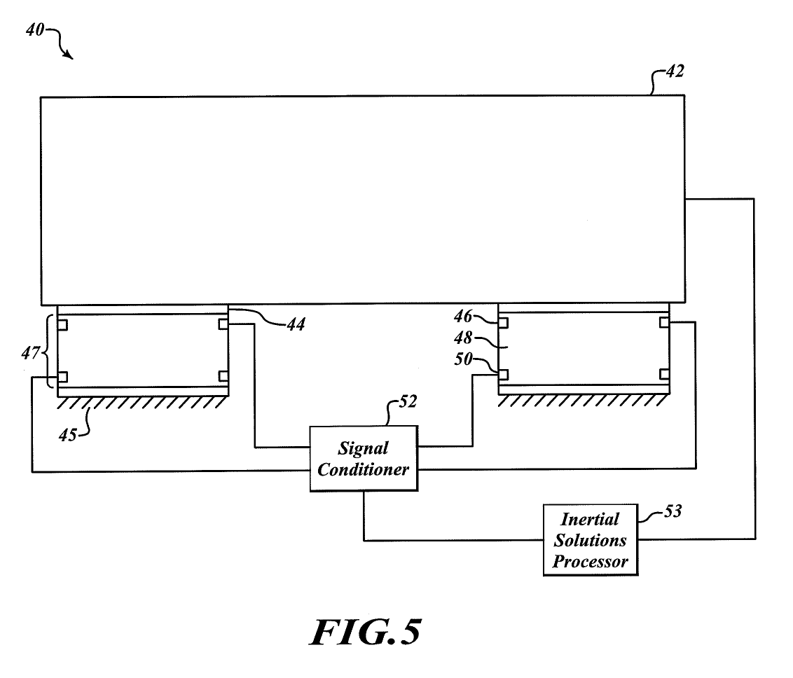

FIG. 5 illustrates an IMU 40 in accordance with another embodiment of the present invention. The IMU 40 includes an ISA 42, multiple integrated isolators 44, and a chassis 45. The integrated isolators 44 each have an inductive transducer 47 and a shock absorbing component 48 (e.g., an elastomeric material). The inductive transducer 47 includes a primary coil 50 and a secondary coil 46, which are each positioned within the shock absorbing component 48 of the integrated isolators 44. The secondary coil 46 is positioned above the primary coil 50.

In this embodiment, when the isolator 44 is compressed or extended, the secondary coil 46 changes position relative to the primary coil 50. This change in position causes a corresponding change in an AC voltage that is coupled from the primary 50 and secondary 46 coils. A representative voltage signal is sensed and processed by the signal conditioner 52, and then transmitted to the inertial solutions processor 53, which determines an angular deflection of the ISA 42.

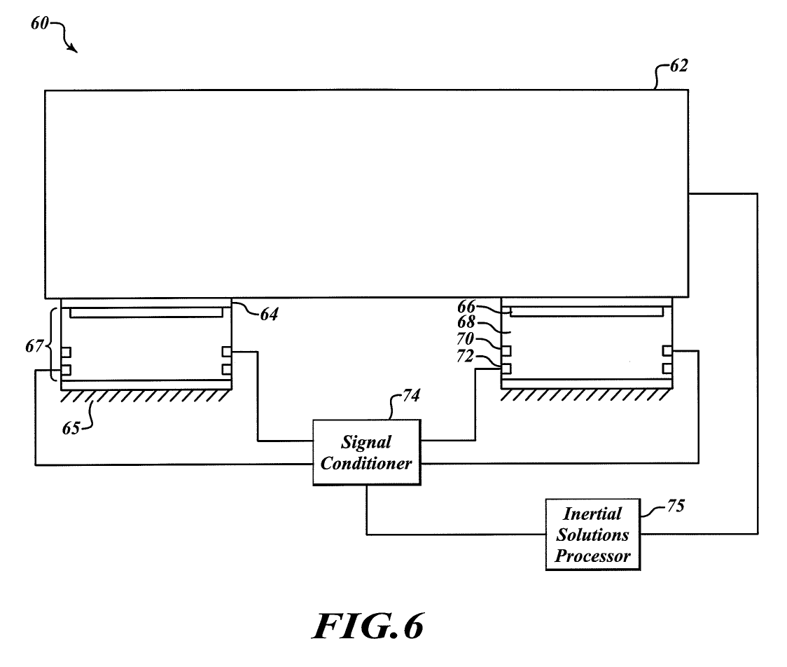

FIG. 6 illustrates an IMU 60 in accordance with another embodiment of the present invention. The IMU 60 includes an ISA 62, multiple integrated isolators 64, and a chassis 65. The integrated isolators 64 each have an eddy current transducer 67 and a shock absorbing component 68 (e.g., an elastomeric material). The eddy current transducer 67 includes an active coil 70, a reference coil 72, and a conductive plate 66, which are each positioned within the shock absorbing component 68 of the integrated isolators 64. The conductive plate 66 is positioned above the active coil 70, which is positioned above the reference coil 72.

In this embodiment, when the isolator 64 is compressed or extended, the active coil 70 and the reference coil 72 changes location relative to the conductive plate 66. This change in position causes a change in the inductance of the active coil 70 and of the reference coil 72 to a lesser degree. The difference in inductance between the two coils can be converted to a voltage value by an inductive bridge circuit (not shown). This signal conditioning is identical to the signal conditioning for the capacitive transducers 16. At this point, the external signal processors 74 and 75 determine an angular deflection of the ISA 62, similarly to the other electro-magnetic embodiments, above.

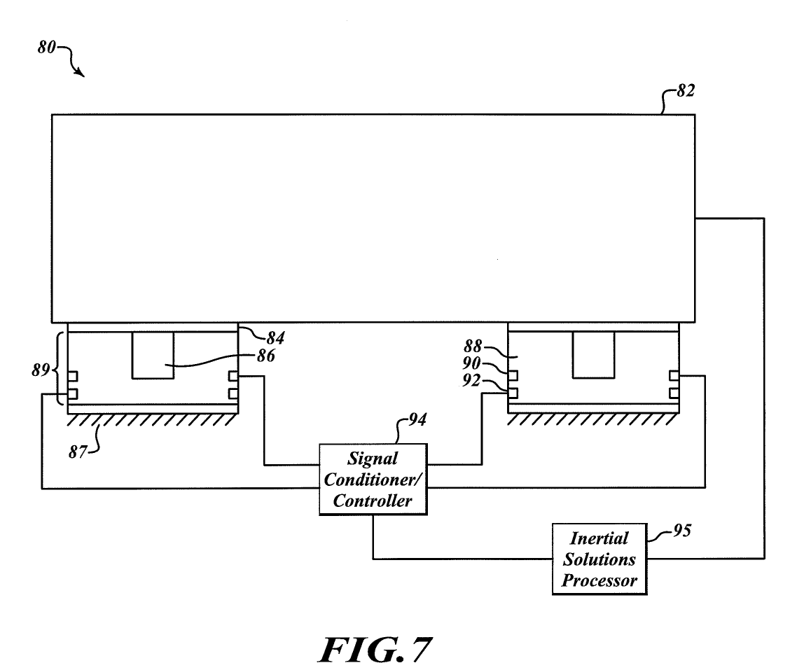

FIG. 7 illustrates an IMU 80 in accordance with another embodiment of the present invention. The IMU 80 includes an ISA 82, multiple integrated isolators 84, and a chassis 87. The integrated isolators 84 each have an active transducer 89 and a shock absorbing component 88 (e.g., an elastomeric material). The active transducer 89 includes a pickoff coil 90, a drive coil 92, and a magnetic core 86, which are each positioned within the shock absorbing component 88 of the integrated isolators 84. The magnetic core 86 is positioned above the pickoff coil 90, which is positioned above the drive coil 92.

In this embodiment, when the isolator 84 is compressed or extended, the magnetic core 86 moves inside of the pickoff coil 90, changing a current in the pickoff coil 90. This current is a measure of the dynamic deflection of the isolator 84. A current delivered to the drive coil 92 based on the sensed current forms a magnetic field, which can cause either an attractive or a repulsive force between the drive coil 92 and the magnetic core 86. These drive forces will affect a change in deflection of the isolator 84. A properly configured controller delivers current to the drive coil 92 in such a way that it will generate drive forces to counteract the external forces on the system as measured with the pickoff coil 90.

In an embodiment, the signal conditioner 94 includes the controller that drives the drive coil 92. The signal conditioner 94 and the inertial solutions processor 95 determine and angular deflection of the ISA 82.

An embodiment of the present invention employs three or more integrated isolators which can be positioned along different orthogonal axes of an IMU chassis or ISA. In this configuration, displacement measurements enable three-dimensional angular deflection compensation of the ISA with respect to the chassis. Any number of integrated isolator components can be used in accordance with various embodiments of the present invention, without departing from the intended scope of the invention.

In an embodiment, the capacitive isolators are built up from a number of layers of elastomer sheet material and metal foil. Alternating layers of the metal foil would extend beyond the elastomer layers in one direction so that they could be connected up together electrically. Two such alternating groups would be formed so that they were intermeshed. In an embodiment, the electro-magnetic isolators would be built up by casting the elastomer in a mold. The various coils and cores would be suspended within the empty mold in their proper locations. The elastomer in its liquid form would be introduced into the mold and subsequently hardened.

While various embodiments of the invention have been illustrated and described, many changes can be made in accordance with other embodiments of the present invention. Accordingly, the scope of the invention is not limited by the disclosure of any particular embodiment. Instead, the invention should be determined entirely by reference to the claims that follow.

The embodiments of the invention in which an exclusive property or privilege is claimed are defined as follows:

1. An internal measurement unit (IMU) for determining precision vehicle orientation information, the apparatus comprising:
a chassis having a first interior surface;
an inertial sensor assembly (ISA) disposed within the chassis and having a first exterior surface; and
at least one integrated suspension element mounted to the first interior surface and the first exterior surface,
wherein the at least one integrated suspension element comprises a first sensor that senses a displacement measurement of the ISA with respect to the chassis to determine an angular deflection.

2. The IMU of claim 1, wherein the at least one integrated suspension element further comprises an elastomeric isolator.

3. The IMU of claim 2, wherein the first sensor of the at least one integrated suspension element is a capacitive transducer.

4. The IMU of claim 2, wherein the first sensor of the at least one integrated suspension element is an electro-magnetic transducer.

5. The IMU of claim 3, further comprising a plurality of integrated suspension elements, wherein the capacitive transducers of the plurality of integrated suspension elements independently measure isolator compression as a displacement measurement.

6. The IMU of claim 4, further comprising a plurality of integrated suspension elements, wherein the electro-magnetic transducers of the plurality of integrated suspension elements independently measure isolator compression as a displacement measurement.

7. The IMU of claim 5, further comprising a processing device coupled to the plurality of integrated suspension elements, the processing device being configured to determine an angular deflection from the displacement measurements.

8. The IMU of claim 6, further comprising a processing device coupled to the plurality of integrated suspension elements, the processing device being configured to determine an angular deflection from the displacement measurements.

9. The IMU of claim 7, wherein the processing device determines the angular deflection by comparing isolator compression measurements amongst the plurality of integrated suspension elements.

10. The IMU of claim 8, wherein the processing device determines the angular deflection by comparing isolator compression measurements amongst the plurality of integrated suspension elements.

11. The IMU of claim 10, wherein the electro-magnetic transducers of the plurality of integrated suspension elements are linear variable differential transducers.

12. The IMU of claim 10, wherein the electro-magnetic transducers of the plurality of integrated suspension elements are active transducers.

13. A method for determining precision vehicle orientation information with an inertial sensor assembly (ISA) disposed within a chassis of an inertial measurement unit (IMU), the method comprising:
sensing a first displacement measurement with a first integrated suspension element, wherein the first integrated suspension element is attached to both the ISA and the chassis;
sensing a second displacement measurement with a second integrated suspension element, wherein the second integrated suspension element is attached to both the ISA and the chassis;
comparing the first and second displacement measurements; and
determining an angular deflection of the ISA based on the compared first and second displacement measurements.

14. The method of claim 13, further comprising sensing a third displacement measurement with a third integrated suspension element and then comparing the first, second, and third displacement measurements to determine an angular deflection of the ISA.

15. The method of claim 13, wherein determining the angular deflection of the ISA further comprises comparing displacement measurements of at least four integrated suspension elements.

16. The method of claim 13, wherein the first and second integrated suspension elements each comprise an elastomeric isolator and a capacitive transducer.

17. The method of claim 13, wherein the first and second integrated suspension elements each comprise an elastomeric isolator and an electro-magnetic transducer.

18. The method of claim 16, wherein the capacitive transducers of the first and second integrated suspension elements independently measure isolator compression as a displacement measurement.

19. The method of claim 17, wherein the electro-magnetic transducers of the first and second integrated suspension elements independently measure isolator compression as a displacement measurement.

20. The method of claim 19, wherein the electro-magnetic transducers of the first and second integrated suspension elements are linear variable differential transducers.
